(19) United States
(12) Patent Application Publication
(10) Pub. No.: US 2007/0046473 A1
(43) Pub. Date: Mar. 1, 2007

(54) Device for recognizing articles having radio frequency tag attached to the articles

(75) Inventor: Masakazu Kato, Numazu (JP)

Correspondence Address: HARNESS, DICKEY & PIERCE, P.L.C., P.O. BOX 828, BLOOMFIELD HILLS, MI, 48303, US

(73) Assignee: Toshiba Tec Kabushiki Kaisha

(21) Appl. No.: 11/511,673

(22) Filed: Aug. 29, 2006

(30) Foreign Application Priority Data
Aug. 31, 2005 (JP) 2005-251263

(51) Int. Cl. G08B 13/14

(52) U.S. Cl. 340/572.1

(57) ABSTRACT

An article recognition device includes a scanner base. A first tag communication antenna and a second tag communication antenna are provided on the scanner base. A direction of an axis of directivity of the first tag communication antenna faces a direction of an axis of directivity of a first tag antenna that a first radio frequency tag provided on an article has. A direction of an axis of directivity of the second tag communication antenna faces a direction of an axis of directivity of a second tag antenna that a second radio frequency tag provided on the same article has. The respective axes of directivity of the first tag communication antenna and the second tag communication antenna cross each other.

### CROSS-REFERENCE TO RELATED APPLICATIONS

This application is based upon and claims the benefit of priority from prior Japanese Patent Application No. 2005-251263, filed Aug. 31, 2005, the entire contents of which are incorporated herein by reference.

### BACKGROUND OF THE INVENTION

1. Field of the Invention

The present invention relates to a device for recognizing an article having a radio frequency tag attached thereto, for example, a device for recognizing a bill, a document, an envelope, a plastic card, a compact disc, a digital versatile disk and the like.

2. Description of the Related Art

In recent years, attention has been focused on a radio frequency tag system that is comprised of a radio frequency tag and a reader/writer. In general, the radio frequency tag is configured with an IC chip and an antenna are provided on a small, thin, rectangular base. A specific identification (ID) is set in a memory of the IC chip. The reader/writer makes communication in a non-contact manner utilizing radio with the radio frequency tag, and reads the ID or the like from the radio frequency tag. In addition, this reader/writer can write and read out arbitrary data to and from the memory of the radio frequency tag.

A collision proof function called anti-collision is employed for communication control between the radio frequency tag and the reader/writer. With this function, even if a plurality of radio frequency tags exist in a communication region of an antenna of one reader/writer, data on each radio frequency tag can be read in a batch.

Then, a radio frequency tag is attached to each of sheets of paper bundled in one block. In addition, a database having stored therein IDs of the radio frequency tags attached to the sheets of paper is created for each item of information for identifying each sheet of paper. A user reads an ID of the radio frequency tag attached to each of the sheets of paper bundled in one block by means of the reader/writer. As a result, it is possible to recognize what kinds of sheets of paper exist in one block within a short period of time.

However, if one radio frequency tag overlaps the other radio frequency tag, a recognition rate is lowered. This is because the radio frequency tags having overlapped each other causes interference. Thus, in a state in which sheet-like articles such as sheets of paper are bundled, a recognition rate of the radio frequency tags attached to the sheet-like articles has been low.

Such a problem has been solved by a method described in Jpn. Pat. Appln. KOKAI Publication No. 2002-230491. That is, a stay that tilts gradually forwardly from a bottom plate to a top plate is mounted on an internal face of a back plate of a housing box for housing a bundle of sheet-like articles. By doing this, the adjacent sheet-like articles are shifted gradually forwardly. Therefore, the radio frequency tags of the adjacent articles never overlap completely.

However, in recent radio frequency tags, with their technical advancement, even in a state in which the radio frequency tags overlap completely each other, a recognition rate can be prevented from being lowered. This is caused by gain improvement of an antenna that the reader/writer comprises or an antenna that each radio frequency tag has. Further, this is also caused by lowering of startup power required for the operation of radio frequency tags. Thus, there is no need for gradually displacing the sheet-like articles.

On the other hand, it has been found from testing that the following problem occurs with the recent radio frequency tags. As shown in FIG. 14, one of the radio frequency tags 1, 2, 3, 4, 5, . . . having overlapped on each other, i.e., a radio frequency tag 3 is displaced in a long-edge direction (in the direction indicated by the arrow A). Thus, a recognition rate between this displaced radio frequency tag and each of the radio frequency tags 2 and 4 adjacent thereto is lowered. For example, in a commercially available rectangular radio frequency tag in the 2.4-GHz band, when a displacement quantity δ in its long-edge direction is about 10 mm, a recognition rate is significantly lowered.

A value of a displacement when a recognition rate is lowered is different depending on a resonance frequency of the radio frequency tag, the shape of an antenna and the like. The cause is not clarified yet. However, the following cause is considered. If one radio frequency tag 3 is displaced, this radio frequency tag 3 interferes with the adjacent radio frequency tags 2 and 4. If interference occurs between the radio frequency tags, the impedance of the antenna of each of the radio frequency tags 2, 3, and 4 drastically changes. When the impedance changes, required receiving electric power cannot be obtained. In this manner, a recognition rate is lowered.

Therefore, in the case where sheet-like articles such as sheets of paper are recognized using radio frequency tags formed in the same shape, the radio frequency tags are attached at the same positions of all the articles. Then, all of the articles are recognized in a state in which they are all aligned. By doing this, it is possible to avoid a situation in which articles cannot be recognized due to a positional relationship between the adjacent radio frequency tags.

However, in the case where a number of sheet-like articles such as sheets of paper have been housed in a rack, a file box and the like, a slight displacement generally occurs with the articles. Thus, manual work of arranging articles in place is required in order to eliminate the displacements of the radio frequency tags attached to the sheet-like articles, respectively.

### BRIEF SUMMARY OF THE INVENTION

There has been a demand for increasing a recognition rate of a plurality of articles having radio frequency tags attached thereto, respectively.

An article recognition device comprises: a first tag communication antenna having an axis of directivity in a direction facing a direction of an axis of directivity of a first tag antenna that a first radio frequency tag has, the first radio frequency tag being provided on an article and shaped to have a short edge and a long edge which is greater than the short edge; a second tag communication antenna having an axis of directivity in a direction facing a direction of an axis of directivity of a second tag antenna that a second radio frequency tag has, the second radio frequency tag being provided on the article and shaped to have a short edge and a long edge which is greater than the short edge; and a scanner base having provided thereon the first tag communication antenna and the second tag communication antenna, wherein the respective axes of directivity of the first tag communication antenna and the second tag communication antenna cross each other.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram depicting a schematic configuration of an article recognition device according to an embodiment of the present invention;

FIG. 2 is a schematic view showing a positional relationship between a first tag communication antenna and a second tag communication antenna and a positional relationship between a first radio frequency tag and a second radio frequency tag provided on articles;

FIG. 3 is a plan view showing an example of articles having a first radio frequency tag and a second radio frequency tag provided thereon;

FIG. 4 is a schematic view showing a relationship of directivity of each one of a tag communication antenna and a radio frequency tag antenna;

FIG. 5 is a schematic view showing a state of displacement when sheet-like articles have been housed in a file box;

FIG. 6 is a schematic view showing a state in which one of the sheet-like articles housed in a file box has been displaced forwardly;

FIG. 7 is a perspective view showing a state of a first radio frequency tag provided on each of the sheet-like articles;

FIG. 8 is a perspective view showing a state of a second radio frequency tag provided on each of the sheet-like articles;

FIG. 9 is a graph depicting a comparison result of a recognition rate in the case of the present embodiment and in the conventional case;

FIG. 10 is a schematic view showing another embodiment of a scanner base;

FIG. 11 is a plan view showing a file folder with a radio frequency tag that is an example of an article housing;

FIG. 12 is a plan view showing a file folder with a housing pocket that is another example of an article housing;

FIG. 13 is a plan view showing an example of articles having three radio frequency tags provided thereon; and

FIG. 14 is a schematic view showing a displacement of a radio frequency tag.

### DETAILED DESCRIPTION OF THE INVENTION

Now, the best mode for carrying out the present invention will be described with reference to the accompanying drawings. The present embodiment is provided as an example of making recognition while radio frequency tags formed in the same shape are attached to a plurality of sheet-like articles of the same size, respectively. The sheet-like articles include sheets of paper such as bills, documents or envelopes, plastic cards, compact discs, digital versatile discs and the like.

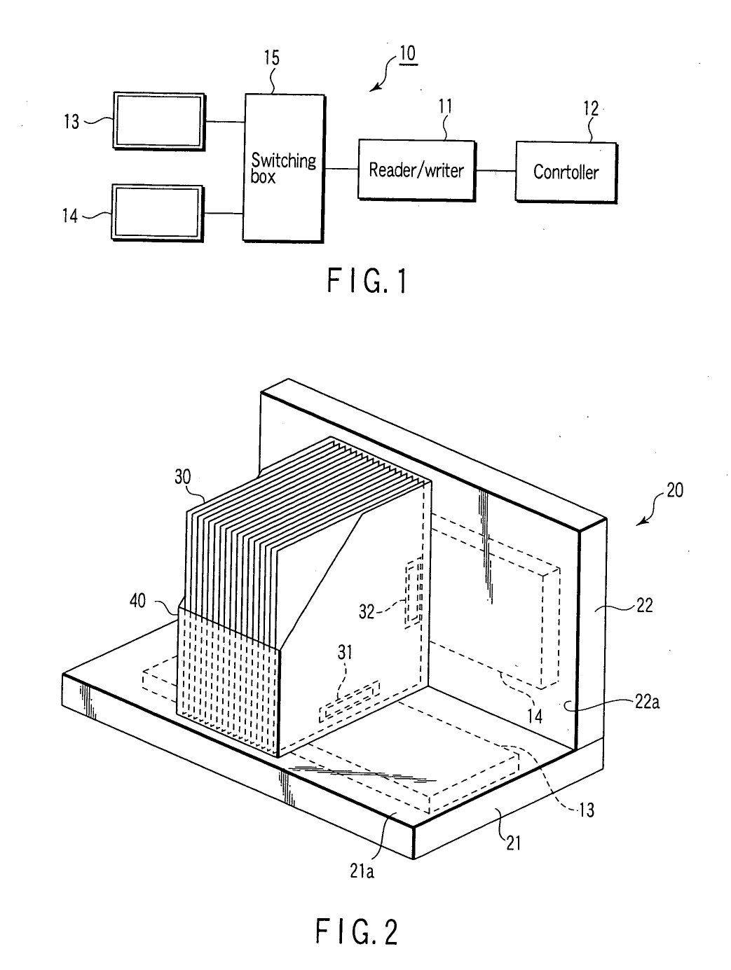

FIG. 1 is a block diagram depicting a schematic configuration of an article recognition device 10 in the present embodiment. The article recognition device 10 is composed of: a radio frequency tag reader/writer 11; a controller 12 that controls this reader/writer 11; a first tag communication antenna 13; a second tag communication antenna 14; and a switching box 15. The switching box 15 serves to switch a tag communication antenna connected to the reader/writer 11 to the first tag communication antenna 13 or the second tag communication antenna 14.

The reader/writer 11 connects to the controller 12 via a wired or wireless communication line. The switching box 15 selects either one of the antennas 13 and 14 in a predetermined or indefinite cycle. Then, the selected antenna is connected to the reader/writer 11.

FIG. 2 is a schematic view of a scanner base 20. The first tag communication antenna 13 and, the second tag communication antenna 14 are provided on the scanner base 20.

The scanner base 20 is composed of a receptacle plate 21 and a back plate 22. The back plate 22 fixes vertically along one edge of the receptacle plate 21. A horizontal face 21a is formed on the receptacle plate 21. A vertical face 22a is formed on the back face 22 so as to be orthogonal to the above horizontal face 21a.

The first tag communication antenna 13 is embedded in the receptacle plate 21 so as to have directivity upside of the horizontal face 21a that the receptacle plate 21 has. The second tag communication antenna 14 is embedded in the back plate 22 so as to have directivity forwardly of the vertical face 22a that the back plate 22 has.

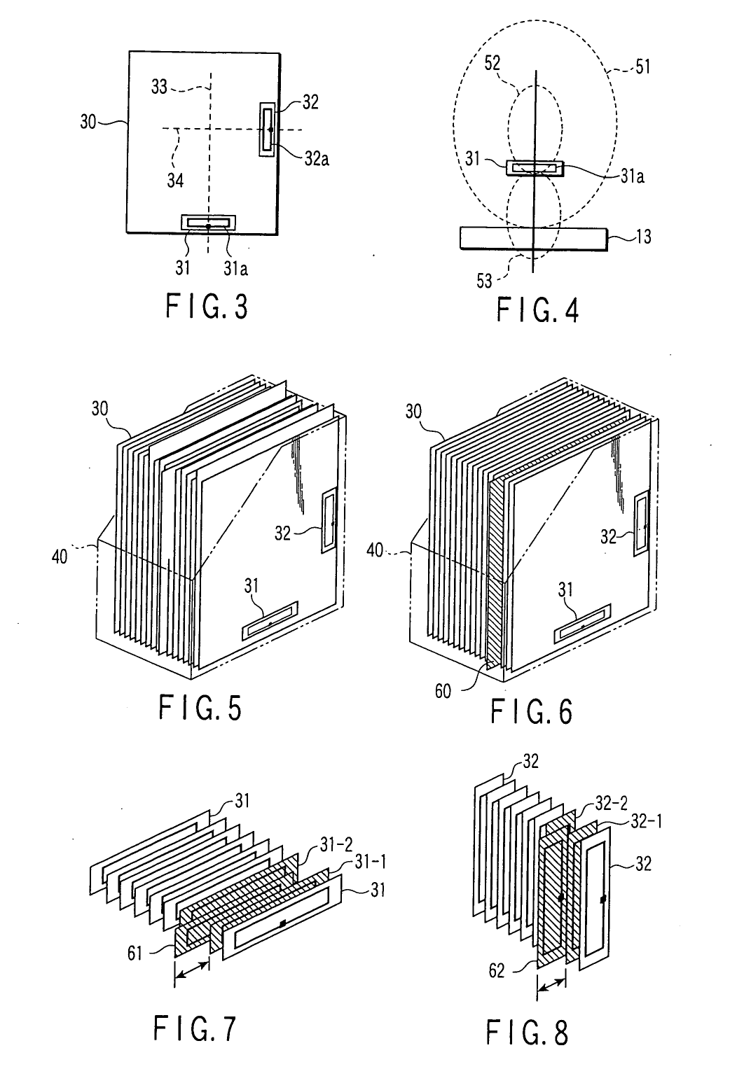

On the thus configured scanner base 20, for example, a file box 40 is placed. A plurality of sheet-like articles 30 are bundled and housed in the file box 40. A first radio frequency tag 31 and a second radio frequency tag 32 are attached to each one of the sheet-like articles 30, as shown in FIG. 3. The first radio frequency tag 31 and the second radio frequency tag 32 are formed in the same shape. Their shape is a rectangle having a short edge and a long edge greater than the short edge. The first radio frequency tag 31 is attached to the sheet-like article 30 so that its long edge is substantially parallel to one edge of the sheet-like article 30. The second radio frequency tag 32 is attached to the sheet-like article 30 so that its long edge is substantially parallel to the other edge in a direction vertical to such one edge of the sheet-like article 30.

In FIG. 3, a dashed line 33 indicates an axis of directivity that a tag antenna 31a provided on the first radio frequency tag 31 has. A dashed line 34 indicates an axis of directivity that a tag antenna 32a provided on the second radio frequency tag 32 has. The directivity axes 33 and 34 each denote a direction of a maximum gain. That is, two radio frequency tags 31 and 32 formed in the same shape are provided on one sheet-like article 30 so that one axis of directivity that each of the antennas has is orthogonal to the other axis.

Different IDs are stored in memories of IC chips of a plurality of radio frequency tags 31 and 32, each of which is provided on each one of the sheet-like articles 30. In addition, article identification information for identifying the sheet-like articles 30 is written in advance in a user area of the above memory. That is, different IDs and common article identification information are stored in memories of the two radio frequency tags 31 and 32 provided on one of the sheet-like articles 30.

A plurality of sheet-like articles 30, each of which has two radio frequency tags 31 and 32 attached thereto, are housed in the file box 40. At this time, these articles are housed in the file box 40 so that the radio frequency tags 31 and 32 of the sheet-like articles 30 overlap each other while the articles each are sandwiched therebetween.

The file box 40 having a plurality of sheet-like articles 30 housed therein is placed on the receptacle plate 21 of the scanner base 20. At this time, as shown in FIG. 2, all of the first radio frequency tags 31 of the sheet-like articles 30 are positioned at the side of the receptacle plate 21, and all of the second radio frequency tags 32 are positioned at the side of the back plate 22. In this manner, an article recognition operation by the article recognition device 10 is executed.

First, a command for instructing start of the article recognition operation is transmitted from the controller 12 to the reader/writer 11. The reader/writer 11 modulates a tag inquiry signal upon the receipt of this start command, and then, outputs the modulated signal to the switching box 15. The switching box 15 alternately switches connection of the reader/writer 11 and each of the antennas 12 and 13. Therefore, radio waves of the inquiry signals are alternately transmitted from the first tag communication antenna 13 and the second tag communication antenna 14.

The radio tags 31 and 32 having received the radio waves of the inquiry signals by the tag antennas with good sensitivity are activated. From the activated radio frequency tags 31 and 32, article identification information stored in a memory is modulated to a radio wave, and the modulated radio wave is transmitted. The radio waves of the article identification information are received by the tag communication antennas 13 and 14, each of which is an inquiry signal transmission source. Then, the received radio waves are sent to the reader/writer 11 via the switching box 15, and then, are demodulated to article identification information. The demodulated article identification information is transmitted to the controller 12. In this manner, the sheet-like articles 30 in the file box 40 placed on the scanner base 20 are recognized in the controller 12.

FIG. 4 shows a relationship between a directivity 51 that the first tag communication antenna 13 has and each of directivities 52 and 53 that the tag antenna 31a provided on the first radio frequency tag 31 has, when the file box 40 has been placed on the scanner base 20, as shown in FIG. 2.

As described previously, the tag communication antenna 13 has directivity 51 upside of the horizontal face 21a that the receptacle plate 21 has. On the other hand, the tag antenna 31a has directivities 52 and 53 in a direction parallel to an attachment face to an article while sandwiching the antenna 31a therebetween. Therefore, the axis of directivity 51 of the first tag communication antenna 13 faces to the axis of the downward directivity 53 that the tag antenna 31a of the first radio frequency tag 31 has. In this manner, the first tag communication antenna 13 enables stable communication with the first radio frequency tag 31.

Similarly, the axis of directivity of the second tag communication antenna 14 faces to the axis of directivity opposite to the forward direction that the tag antenna 32a of the second radio frequency tag 32 has. In this manner, the second tag communication antenna 14 enables stable communication with the second radio frequency tag 32.

In the meantime, in the case where a plurality of sheet-like articles 30 have been housed in the file box 40, in most cases, some of the sheet-shape articles 30 are displaced in an upper direction or a forward/backward direction, as shown in FIG. 5. Before, there has been concern that a radio frequency tag recognition rate is lowered by this displacement. In contrast, according to the present embodiment, a good recognition rate can be ensured. The reason will be described below.

For the sake of simplification, as shown in FIG. 6, let us consider an example in which only one of the arranged sheet-like articles 30, i.e., an article 60 has been displaced forwardly. FIG. 7 shows a positional relationship between the first radio frequency tags 31 and 61 provided on sheet-like articles 30 and 60 in the above case. In addition, FIG. 8 shows a positional relationship between the second radio frequency tags 32 and 62. The first radio frequency tag 61 indicates a first radio frequency tag provided on the sheet-like article 60 displaced forwardly. The second radio frequency tag 62 indicates a second radio frequency tag provided on the same sheet-like article 60.

As shown in FIG. 7, if one rectangular radio frequency tag 61 is displaced in its long-edge direction, it becomes difficult to read this radio frequency tag 61 and radio frequency tags 31-1 and 31-2 adjacent thereto. In this case, whether or not the tags can be read depends on a displacement quantity 6. For example, in the case of a commercially available radio frequency tag in 2.4 GHz band, if the displacement quantity δ becomes about 10 mm, the tag cannot often be read. This displacement quantity δ when it is difficult to read the tag is different depending on type or shape of a tag. A value of displacement of 10 mm is merely provided as an example.

On the other hand, in the case where the first radio frequency tag 61 provided on the sheet-like article 60 is displaced forwardly by the displacement quantity δ, the second radio frequency tag 62 provided on the same sheet-like article 60 is unavoidably displaced forwardly by the displacement quantity δ, as shown in FIG. 8. However, in the case where one rectangular radio frequency tag 62 has been displaced in its short-edge direction, this radio frequency tag 62 and the radio frequency tags 32-1 and 32-2 adjacent thereto can be read smoothly without any problem. This is estimated to be because interference with the adjacent radio frequency tags has often occurred in the displacement in the long-edge direction, whereas interference with the adjacent radio frequency tags slightly occurs in the displacement in the short-edge direction.

Therefore, as shown in FIG. 6, in the case where the sheet-like article 60 has been displaced forwardly, the first radio frequency tag 31 cannot be read. However, the second radio frequency tag 32 can be read via the second tag communication antenna 14. The controller 12 can check location of the sheet-like article 30 as long as either one of the radio frequency tags 31 and 32 can be read. Therefore, even if the sheet-like article 30 is shifted forwardly, it becomes possible to recognize each of the articles at a high recognition rate.

In addition, this also applies to a case in which the sheet-like article 30 has been displaced upwardly in the file box 40. That is, in the case where the sheet-like article 30 has been displaced upwardly, the second radio frequency tag 32 is displaced in the long-edge direction. However, the first radio frequency tag 31 is displaced in the short-edge direction. Thus, even if the second radio frequency tag 32 cannot be read, there is a high possibility that the first radio frequency tag 31 can be read via the first tag communication antenna 13. Therefore, even if the sheet-like article 30 is displaced upside, it becomes possible to recognize each of the articles at a high recognition rate.

In practice, a total of 3600 sheets of rectangular paper having radio frequency tags attached thereto were placed in the file box 40, and a radio frequency tag recognition rate when the sheets of paper were properly displaced was obtained by testing. In the testing, the maximum quantities of displacements of the sheets of paper were limited to four patterns below.
(1) 15 mm on forward side and 15 mm on upper side
(2) 10 mm on forward side and 15 mm on upper side
(3) 15 mm on forward side and 5 mm on upper side
(4) 10 mm on forward side and 5 mm on upper side

The displacement quantity used here denotes a quantity obtained when sheets of paper have been displaced in a forward direction or an upward direction from a state in which they have been housed so as to come into contact with an internal face of the file box 40.

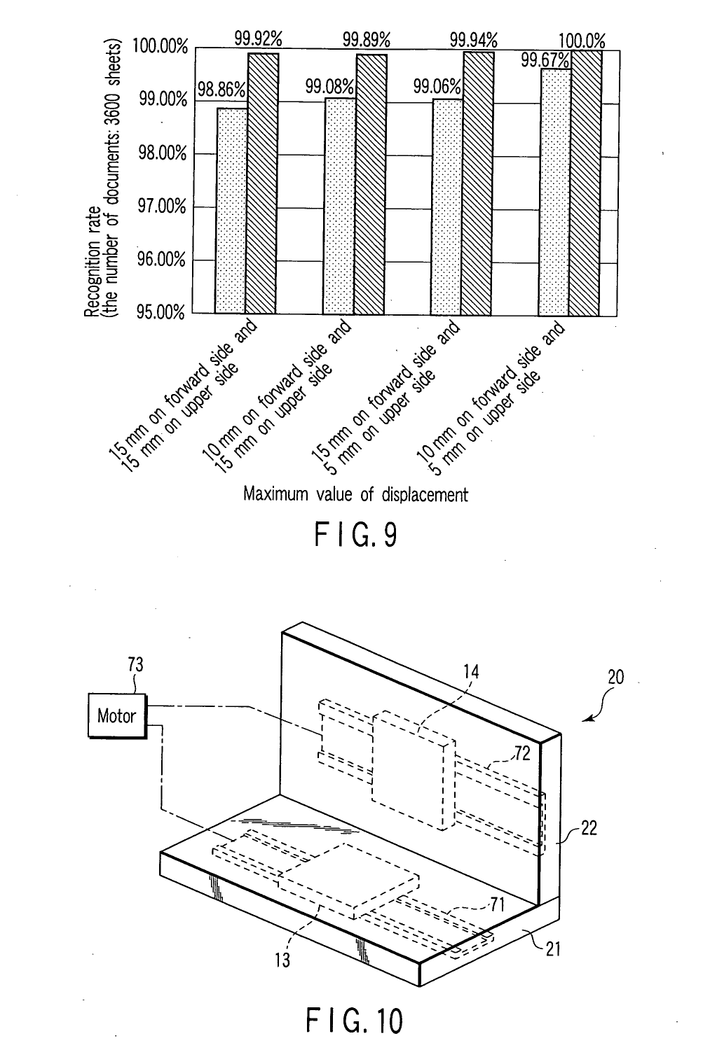

A result of the testing is graphically shown in FIG. 9. In the figure, the left dotted bar graph indicates a recognition rate in a conventional case. That is, this graph indicates a recognition rate in the case where the radio frequency tag 31 has been attached to only one edge (bottom edge) of paper. On the other hand, the right shaded bar graph indicates a recognition rate in the present embodiment. That is, this graph indicates a recognition rate in the case where the first radio frequency tag 31 and the second radio frequency tag 32 have been attached to one edge (bottom edge) and the other edge (edge in height direction vertical to bottom edge), respectively. In the case of the present embodiment, it is sufficient if data on either one of the first radio frequency tag 31 and the second radio frequency tag 32 can be read.

For example, in the case of pattern (1) including displacement of 15 mm at maximum on the forward side and displacement of 15 mm at maximum on the upward side, a recognition rate is 98.86% in the conventional case, whereas a recognition rate is improved to 99.92% in the case of the present embodiment. With respect to the cases of the other patterns (2) to (4) as well, the recognition rates in the present embodiment are improved compared with the recognition rates in the conventional case. The two radio frequency tags 31 and 32 are attached to paper so that axes 33 and 34 of directivity that tag antennas 32a and 32b have cross each other, thereby making it possible to improve the recognition rate.

Now, a second embodiment will be described here. FIG. 10 is a schematic view showing a scanner base 20 according to the second embodiment. In general, the size of an antenna is affected by restriction on a communication distance or a radio wavelength required for its usage. Thus, there is a case in which one antenna cannot cover a horizontal face full area or a vertical face full area of the scanner base 20.

Therefore, in the second embodiment, a first antenna guide 71 for guiding movement of a first tag communication antenna 13 is provided on a receptacle plate 21. In addition, a second antenna guide 72 for guiding movement of a second tag communication antenna 14 is provided on a back plate 22. Further, a motor 73 for moving the first tag communication antenna 13 and the second tag communication antenna 14 is provided.

When the electromotive force of the motor 73 is transmitted, the first and second tag communication antennas 13 and 14 are guided by means of the antenna guides 71 and 72, respectively, and move. That is, the first and second tag communication antennas 13 and 14 can slide in a direction orthogonal to an axis of directivity that the antennas have on their own.

In the second embodiment, in the case where a plurality of file boxes 40 have been mounted on the scanner base 20, the first and second tag communication antennas 13 and 14 are slid to the left and right. By doing this, all of the sheet-like articles 30 in each of the file boxes 40 can be precisely recognized.

In each of the foregoing embodiments, the sheet-like article 30 is placed in the file box 40. However, the sheet-like article 30 may not be placed in the file box 40. For example, a partition plate is provided on the scanner base 20 so that the sheet-like article 30 may be directly erected.

In addition, in each of the foregoing embodiments, the radio frequency tags 31 and 32 are directly attached to the sheet-like article 30. However, the radio frequency tags 31 and 32 may not be directly attached to the sheet-like article 30. For example, there is used an article housing such as a file folder capable of housing the sheet-like article 30. The first radio frequency tag 31 and the second radio frequency tag 32 are attached in advance to the article housing. An axis 33 of directivity that a tag antenna 31a of the first radio frequency tag 31 has and an axis 34 of directivity that a tag antenna 32a of the second radio frequency tag 32 has are in mutually crossing relationship.

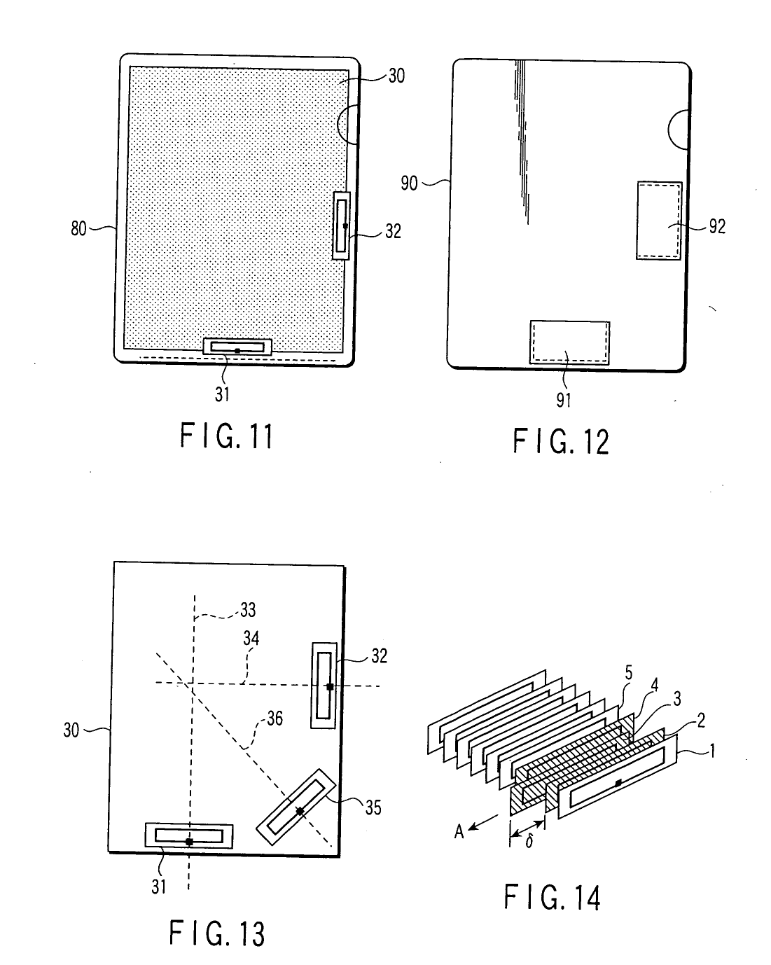

FIG. 11 shows a file folder 80 with a radio frequency tag according to an embodiment of the article housing. A first radio frequency tag 31 is attached to the vicinity of the bottom edge of the file folder 80. A second radio frequency tag 32 is attached to the vicinity of an edge in a height direction vertical to the bottom edge of the file folder 80. The second radio frequency tag 32 is attached in direction rotated by substantially 90 degrees with respect to the first radio frequency tag 31.

Each of the radio frequency tags 31 and 32 may be attached to the file folder 80 by using a viscous tape, an adhesive bonding agent and the like. Alternatively, a viscous film or the like may be attached over the radio frequency tags 31 and 32.

FIG. 12 shows a file folder 90 with a housing pocket according to another embodiment of the article housing. In the file folder 90, there are provided: a first housing pocket 91 for housing the first radio frequency tag 31; and a second housing pocket 92 for housing the second radio frequency tag 32.

The first radio frequency tag 31 is removably housed in the first housing pocket 91. The second radio frequency tag 32 is removably housed in the second housing pocket 92. An axis 33 of directivity that a tag antenna 31a of the first radio frequency tag 31 housed in the first housing pocket 91 has crosses an axis 34 of directivity that a tag antenna 32a of the second radio frequency tag 32 housed in the second housing pocket 92 has.

In the case of the file folder 90 with a housing pocket, there is no need for attaching the radio frequency tags 31 and 32 to the file folder. Therefore, the radio frequency tags 31 and 32 can be reused. In addition, positions at which the radio frequency tags 31 and 32 are set are predetermined. Therefore, a work of attaching the radio frequency tags 31 and 32 to the file folder 90 is facilitated.

Each of the foregoing embodiments shows a case in which two radio frequency tags 31 and 32 are provided on one sheet-like article 30. However, the number of radio frequency tags may be more than 2. For example, as shown in FIG. 13, three radio frequency tags 31, 32, and 35 are attached to the sheet-like article 30 so that axes 33, 34, and 36 of directivity of their tag antennas cross each other. In this case, there is a need for providing tag communication antennas for reading their respective radio frequency tags 31, 32, and 35. However, as more radio frequency tags are disposed so that axes of directivity cross each other, a recognition rate when displacement of an article occurs is improved more remarkably.

While the foregoing embodiments have described that radio frequency tags are formed in a rectangular shape, it is evident that a recognition rate of articles having radio frequency tags attached thereto is improved by applying the present invention even in another shape.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An article recognition device, comprising:
a first tag communication antenna having an axis of directivity in a direction facing a direction of an axis of directivity of a first tag antenna that a first radio frequency tag has, the first radio frequency tag being provided on an article and shaped to have a short edge and a long edge which is greater than the short edge;
a second tag communication antenna having an axis of directivity in a direction facing a direction of an axis of directivity of a second tag antenna that a second radio frequency tag has, the second radio frequency tag being provided on the article and shaped to have a short edge and a long edge which is greater than the short edge; and
a scanner base having provided thereon the first tag communication antenna and the second tag communication antenna,
wherein the respective axes of directivity of the first tag communication antenna and the second tag communication antenna cross each other.

2. The article recognition device according to claim 1, further comprising:
a first guide provided on the scanner base to guide movement of the first tag communication antenna;
a second guide provided on the scanner base to guide movement of the second tag communication antenna; and
a motor which moves the first tag communication antenna and the second tag communication antenna.

3. The article recognition device according to claim 1, wherein a length of the first guide is larger than a length of the first tag communication antenna with respect to a direction in which the first tag communication antenna moves.

4. The article recognition device according to claim 1, wherein the respective axes of directivity of the first tag communication antenna and the second tag communication antenna are orthogonal to each other.

5. The article recognition device according to claim 1, further comprising a file box capable of housing a plurality of the articles, each of which is equipped with the first radio frequency tag and the second radio frequency tag.

6. An article with radio frequency tags, comprising:
an article main body;
a first radio frequency tag provided on the article main body, the first radio frequency tag providing a first tag antenna having directivity on a base having a short edge and a long edge greater than the short edge; and
a second radio frequency tag provided on the article main body, the second radio frequency tag providing a second tag antenna having directivity on a base having a short edge and a long edge greater than the short edge,
wherein respective axes of directivity of the first tag antenna and the second tag antenna cross each other.

7. The article with radio frequency tags according to claim 6, wherein shapes of the respective bases of the first radio frequency tag and the second radio frequency tag are the same.

8. The article with radio frequency tags according to claim 6, wherein a direction of the long edge of the base in the first radio frequency tag and a direction of the long edge of the base in the second radio frequency tag are in an orthogonal relationship.

9. The article with radio frequency tags according to claim 6, wherein the respective axes of directivity of the first tag antenna and the second tag antenna are in an orthogonal relationship.

10. An article housing, comprising:
housing main bodies capable of housing an article therein;
a first radio frequency tag provided on the housing main bodies, the first radio frequency tag providing a first-tag antenna having directivity on a base having a short edge and a long edge greater than the short edge; and
a second radio frequency tag provided on the housing main bodies, the second radio frequency tag providing a second tag antenna having directivity on a base having a short edge and a long edge greater than the short edge,
wherein respective axes of directivity of the first tag antenna and the second tag antenna cross each other.

11. The article housing according to claim 10, wherein a direction of the long edge of the base in the first radio frequency tag and a direction of the long edge of the base in the second radio frequency tag are in an orthogonal relationship.

12. The article housing according to claim 10, wherein the respective axes of directivity of the first tag antenna and the second tag antenna are in an orthogonal relationship.

13. The article housing according to claim 10, wherein the first radio frequency tag and the second radio frequency tag each are removably provided with respect to the housing main body.
